(19) United States
(12) Patent Application Publication
(10) Pub. No.: US 2020/0208611 A1
(43) Pub. Date: Jul. 2, 2020

(54) DEEP-SEA ENERGY INTEGRATED SYSTEM BASED ON FLOATING WIND TURBINE AND CURRENT ENERGY DEVICE

(71) Applicant: Dalian University of Technology, Dalian City, Liaoning Province (CN)

(72) Inventors: Wei SHI, Dalian City (CN); Lin ZHOU, Dalian City (CN); Zhengru REN, Dalian City (CN); Jikun YOU, Dalian City (CN); Dezhi NING, Dalian City (CN); Ying GOU, Dalian City (CN)

(21) Appl. No.: 16/631,330

(22) PCT Filed: May 24, 2018
(86) PCT No.: PCT/CN2018/088231

§ 371 Date: Jan. 15, 2020

(30) Foreign Application Priority Data
Mar. 6, 2018 (CN) 201810211962.X

(51) Int. Cl. F03D 9/00; F03D 9/25; F03D 13/25

(52) U.S. Cl. CPC F03D 9/008; F03D 13/25; F03D 9/25

(57) ABSTRACT

A deep sea energy integration system based on a floating wind turbine and a current energy device, being of a power generation structure having wind turbines with a Spar platform as a foundation and integrating vertical axis current energy device, and having a Spar-type floating wind power generation system and a current energy power generation system. The Spar-type floating wind power generation system is simple in structure and high in stability, is suitable for middle and far sea areas. By combining an offshore wind turbine with the current energy power generation device to share the Spar platform, an mooring line, a voltage transformation device, and a power transmission device, the power generation performance of the system is improved. An outer support of the current energy power generation system is a cylindrical shape, thereby reducing wave loads, utilizing the current energy to the maximum extent.

### FIELD OF THE INVENTION

The present invention belongs to the field of marine renewable energy application technology, particularly relates to a deep-sea energy integrated system based on a floating wind turbine and a current energy device, which is a deep-sea energy system based on a Spar-type floating platform and combines wind energy and current energy.

### BACKGROUND

The ocean is rich in renewable energy. Wind power generation is the most scalable and commercial renewable energy for now and in the future. Offshore wind power is a new direction of clean energy development, which has been widely concerned by scholars and experts from all countries. The development of offshore wind power is of great significance to the adjustment of China's energy structure, the development of green energy and the treatment of air pollution. There are abundant tidal energy in the middle and far sea areas with rich wind energy, and tidal energy generation is not affected by hydrological factors such as flood and low water. It also featured with no dams, strong mobility, and relatively stable output power. However, there are a series of technical problems in the development of tidal energy, such as bad environment, large one-off investment, high equipment cost, low energy conversion rate, installation and maintenance, and power transmission, which to some extent restrict the development of its commercialization. For offshore wind turbine, with the increase of water depth, the construction cost of bottom-fixed turbine will increase dramatically. For water depth more than 60 m, floating foundations are generally used, in which Spar platform has good stability because of its small water surface. At the same time, its natural frequency is far away from the frequency band of wave, its movement is stable, its safety performance is good, but its cost is relatively high.

The current energy device is divided into horizontal axis and vertical axis type. The vertical axis current turbine has a very wide application prospect because it is not affected by the direction of inflow and its structure is simple.

The combination of floating offshore wind turbine and current energy device can effectively reduce the cost of offshore wind power generation, improve the efficiency of current energy utilization, and improve the economy of the overall power generation system, which is an effective way to solve the comprehensive utilization of marine renewable energy.

### SUMMARY

The present invention provides a deep-sea energy integration system based on a floating wind turbine and a current energy device, wherein the wind turbine and the current energy device share a common support structure and a power transportation system. In the middle and far sea area, the large pontoon and anchor chain of the spar are used to build an integrated power generation system integrating wind energy and vertical axis current energy system. The system makes full use of marine renewable energy, improves the utilization efficiency of vertical axis turbine, solves the disadvantages of instability of the current energy device, reduces the total cost of power generation, and improves the overall economic benefits of the offshore wind farm.

The technical solution of the present invention:

A deep-sea energy integration system based on a floating wind turbine and a current energy device, which is a power generation structure integrated a wind turbine and a vertical axis current energy based on a Spar platform, comprises the a Spar floating wind power generation system and a current energy generation system;

the Spar floating wind power generation system comprises two wind turbines 1, a suspender 2, an arrow support frame 3, a tower 4, a Spar platform 5, a mooring line 6 and a power transmission system; the two wind turbines 1 are connected with the tower 4 through the arrow support frame 3, the two wind turbines 1 are connected to each other by the suspender 2, the tower 4 is connected with the Spar platform 5, and is respectively fixed on the seabed through three mooring lines 6;

the current energy device 7 is fixed at the bottom of the Spar platform 5, the current energy device 7 includes an outer H structure 8, a transmission structure 9, an outer support frame structure 10, a central cylinder 11 and a steel beam 12; the outer H structure 8 has three blades, which are uniformly distributed in the circumferential direction; the blades are fixed on the slot connection port of the boom through the connection slot on the boom, and are connected with the central cylinder 11 through the boom, so as to improve the utilization rate of current energy as much as possible; the outer support frame structure 12 is welded by three steel beams 12, the outer support frame structure 12 and the outer H structure 8 are connected as a whole through the transmission structure 9, the three blades are consistent with the flow direction, and the plane of the structure does not need to be adjusted to realize the current power generation.

The current energy device 7 is a vertical axis current energy generator.

The present invention takes full advantage of the floating structure of the Spar platform, sharing common support structure and power transmission system with current energy device.

The beneficial effects of the present invention:

1. Spar-type floating wind turbine has the characteristics of simple structure, high stability, easy installation and provides a wide range of water depth, which is suitable when used in transient or deep water depth.

2. The offshore wind turbine is combined with the current energy device, sharing common facilities like Spar platform, mooring line, voltage transformer and power transmission equipment. This has improved the power generation performance of the system, increased the total electricity capacity and effectively utilize ocean renewable energy, which has reduced investment costs and accelerated the process of commercial applications.

3. The exterior support structure of the current energy device employs a cylindrical shape, which can reduce the wave loads, make full use of the current energy, and guarantee the stability of the whole structure.

### DESCRIPTION OF THE DRAWINGS

FIG. 1 is a structural view of power generation system integrated by floating wind turbine and current energy device in the present invention.

FIG. 2 is a schematic structural view of the current energy device 7.

Wherein: 1 wind turbine; 2 suspender; 3 arrow support frame; 4 tower; 5 Spar platform; 6 mooring line; 7 current energy device; 8 outer H structure; 9 transmission structure; 10 outer support frame structure; 11 central cylinder; 12 steel beam.

### DETAILED DESCRIPTION

In order to deepen the understanding of the present invention, the invention will be further described below in conjunction with the accompanying drawings and technical solutions:

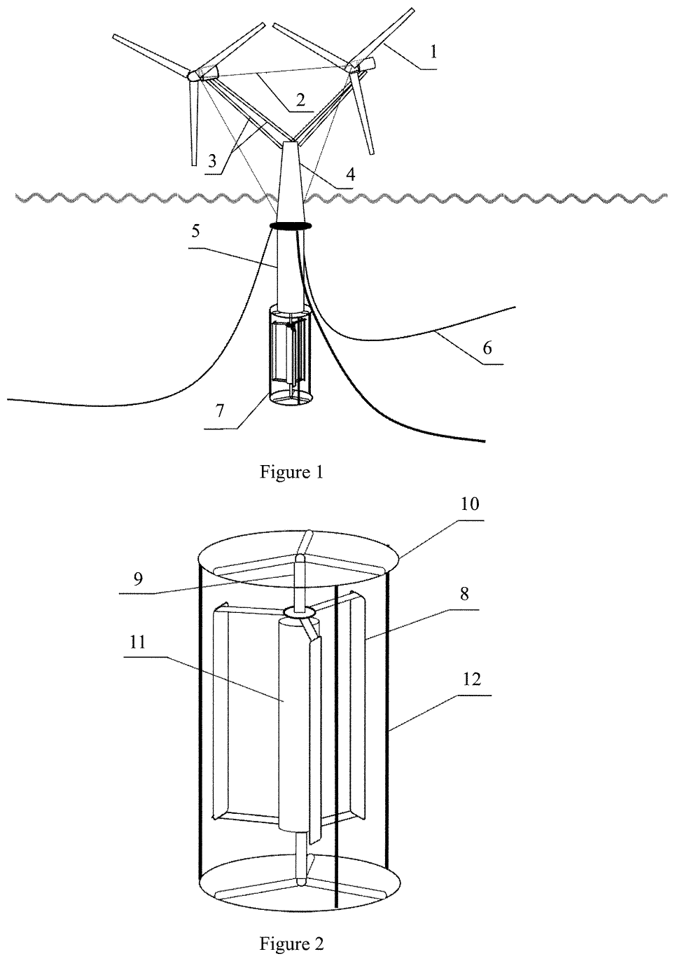

FIG. 1 and FIG. 2 illustrate an embodiment of deep sea energy integrated system based on floating wind turbine and current device.

Implementation method: wind turbines 1 generate electrical energy under the wind inflow; the outer H structure 8 rotate by the force of the coming flow, converting current energy into mechanical energy of the rotating axis, which was converted into electrical energy by current energy device 7. The electrical energy generated by wind turbines 1 and current energy device 7 was transferred through the transmission system to the power grid, and finally go to the land users.

The construction and installation process of the deep sea energy integrated system based on floating wind turbine and current energy device is given as follows: first, transport the Spar platform 5 to the specific sea area by using the floating wind turbine construction technology of the existing Spar platform 5. Then, install the assembled current energy system to the bottom of the Spar platform 5. Next, lift up the Spar platform 5 and connect it to the seabed with three mooring lines 6. Last, install tower 4 and wind turbines 1 on the top of the system, which is the last step of the construction and installation process of the deep sea energy integrated system based on floating wind turbine and current energy device.

The Spar platform 5 used in the present invention has the characteristics of high stability, simple structure, easy construction and low cost. Wind turbines 1 and current energy device 7 share a common support structure and power transmission system by combining with each other, which has reduced the generation cost to some extent, stabilized the whole structure and significantly enhanced the wave load resistance and wind load resistance. This is the further evidence of the feasibility and the remarkable technical characteristics of the present invention, which has provided some suggestions on large scale development and commercialization of the offshore wind power generation and current energy integrated power generation.

1. A deep-sea energy integrated system based on floating wind turbine and current energy device, wherein, the deep-sea energy integrated system combing a wind turbine with Spar floating platform and vertical-axis current energy device, includes a Spar floating wind power generation system and current energy generation system;
the Spar floating wind power generation system comprises two wind turbines (1), suspender (2) arrow support frame (3), tower (4), Spar platform (5), mooring lines (6) and a power transmission system; two wind turbine (1) are connected to tower (4) by the arrow support frame (3); two wind turbines (1) are connected to each other by suspender (2); tower (4) is connected to the Spar platform (5), which is respectively fixed on the seabed by three mooring lines (6);
the current energy device (7) is fixed to the bottom of Spar platform (5); current energy device (7) comprises an outer H structure (8), connection structure (9), outer support frame structure (10), a center cylinder (11) and a steel beam (12); the outer H structure (8) has three blades, which circumferentially uniformly distributed; the blades are fixed on the slot connection port of the boom through the connection slot on the boom, and are connected with the central cylinder (11) through the boom, so as to improve the utilization rate of current energy as much as possible; the outer support frame structure (12) is welded by three steel beams (12), the outer support frame structure (12) and the outer H structure (8) are connected as a whole through the transmission structure (9), the three blades are consistent with the flow direction, and the plane of the structure does not need to be adjusted to realize the current power generation.

2. The deep-sea energy integrated system based on floating wind turbine and current energy device according to claim 1, wherein the current energy device (7) is a vertical axis current energy generator.
